(19) United States
(12) Patent Application Publication
(10) Pub. No.: US 2025/0139701 A1
(43) Pub. Date: May 1, 2025

(54) FINANCIAL MARKET LIST DISPLAY METHOD AND APPARATUS, STORAGE MEDIUM AND DEVICE

(71) Applicant: SHENZHEN FUTU NETWORK TECHNOLOGY CO., LTD., Shenzhen (CN)

(72) Inventor: Like JIANG, Shenzhen (CN)

(21) Appl. No.: 19/008,682

(22) Filed: Jan. 3, 2025

Related U.S. Application Data
(63) Continuation of application No. PCT/CN2023/112651, filed on Aug. 11, 2023.

(30) Foreign Application Priority Data
Aug. 17, 2022 (CN) 202210988920.3

(51) Int. Cl. G06Q 40/04; G06T 11/00; G06T 11/20

(52) U.S. Cl. CPC G06Q 40/04; G06T 11/001; G06T 11/20; G06T 2200/24

(57) ABSTRACT

Provided are a financial market list display method and apparatus, a storage medium, and a device. The method includes: obtaining a list drawing instruction triggered based on a list update event, the list update event including an information update record for a target financial market in a financial market list; determining, based on the list drawing instruction, a target cell corresponding to the target financial market in the financial market list, and redrawing a target content of the target cell based on the information update record of the target financial market by invoking a cell drawing device corresponding to the target cell; and displaying the redrawn target content of the target cell in the financial market list displayed on a display interface.

### CROSS-REFERENCE TO RELATED APPLICATION

The present application is a continuation of International Application No. PCT/CN2023/112651 filed on Aug. 11, 2023, which claims priority to Chinese Patent Application No. 202210988920.3, entitled “FINANCIAL MARKET LIST DISPLAY METHOD AND APPARATUS, STORAGE MEDIUM AND DEVICE”, and filed on Aug. 17, 2022, the entire disclosure of which is incorporated herein by reference.

### FIELD

The present disclosure relates to the field of computer technologies, and in particular, to a financial market list display method and apparatus, a storage medium, and a device.

### BACKGROUND

State values such as financial prices and trading volumes change rapidly when financial markets are active. As one of the primary controls for displaying financial data, a market list is characterized with a display of a large amount of financial data at once and a rapid change in a content of the financial data in real time.

Conventional list controls have difficulty in customizing a cell content, poor reusability, and low efficiency in responding to data changes, which cannot meet requirements of efficient list display.

### SUMMARY

Embodiments of the present disclosure provide a financial market list display method and apparatus, a storage medium, and a device, which can redraw a target content of a target cell by invoking a cell drawing device corresponding to a target cell with a changed financial market in a list, to realize a local change in cell granularity and a high efficiency in responding to data changes, improve drawing efficiency, and thus improve display efficiency and real-time performance of virtual resources.

In an aspect, embodiments of the present disclosure provide a financial market list display method. The method includes:
obtaining a list drawing instruction triggered based on a list update event, the list update event including an information update record for a target financial market in a financial market list;
determining, based on the list drawing instruction, a target cell corresponding to the target financial market in the financial market list, and redrawing a target content of the target cell based on the information update record of the target financial market by invoking a cell drawing device corresponding to the target cell; and
displaying the redrawn target content of the target cell in the financial market list displayed on a display interface.

In some embodiments, the cell drawing device includes a list data module and a list content drawing device; and
said redrawing the target content of the target cell based on the information update record of the target financial market by invoking the cell drawing device corresponding to the target cell includes:
invoking the cell drawing device corresponding to the target cell;
providing list data of the target financial market based on the list data module of the cell drawing device, generating drawing content indication information based on an information update record in the list data of the target financial market; and
redrawing, by using the list content drawing device of the cell drawing device, the target content of the target cell based on the drawing content indication information.

In some embodiments, the method further includes, prior to said providing the list data of the target financial market based on the list data module of the cell drawing device:
determining, based on a data change condition within adjacent predetermined time periods, variation data with a change;
encapsulating the variation data and a business logic used for list processing, and generating a unified interface, to construct the list data module, the list data module being configured to provide the list content drawing device with all information needed for drawing.

In some embodiments, the method further includes, prior to said redrawing, by using the list content drawing device of the cell drawing device, the target content of the target cell based on the drawing content indication information:
encapsulating a display mode of all list cell content to construct the list content drawing device.

In some embodiments, the method further includes, prior to said obtaining the list drawing instruction triggered based on the list update event:
generating the list update event in response to detecting a change in a financial market;
storing into a scintillation dictionary the information update record for the target financial market in the financial market list in the list update event;
starting a timer, and traversing in the scintillation dictionary, in response to the timer having expired, target finance with a changed financial market; and
obtaining a number of time slices corresponding to the target finance, and triggering the list drawing instruction when the number of time slices corresponding to the target finance becomes zero.

In some embodiments, the method further includes, prior to said obtaining the number of the time slices corresponding to the target finance:
reducing the number of time slices corresponding to the target finance.

In some embodiments, the target content includes cell data and a cell background; and the method further includes, in response to said displaying the redrawn target content of the target cell:
when the target content indicates that a price of target finance increases, displaying, within a predetermined time period, cell data and/or a cell background of the target cell based on a first predetermined display mode, the first predetermined display mode comprising any one of a scintillation display, a background color change display, or a cell data color change display; and
when the target content indicates that the price of the target finance falls, displaying, within a predetermined time period, cell data and/or a cell background of the target cell based on a second predetermined display mode, the second predetermined display mode comprising any one of a scintillation display, a background color change display, or a cell data color change display.

In an aspect, embodiments of the present disclosure provide a financial market list display apparatus. The apparatus includes:
an obtaining unit configured to obtain a list drawing instruction triggered based on a list update event, the list update event comprising an information update record for a target financial market in a financial market list;
a processing unit configured to determine, based on the list drawing instruction, a target cell corresponding to the target financial market in the financial market list, and redraw a target content of the target cell based on the information update record of the target financial market by invoking a cell drawing device corresponding to the target cell; and
a display unit configured to display the redrawn target content of the target cell in the financial market list displayed on a display interface.

Further, embodiments of the present disclosure provide a computer device. The computer device includes a processor and a memory having a computer program stored thereon. The processor is configured to invoke the computer program stored in the memory to perform the financial market list display method as described in any of the above embodiments.

Further, embodiments of the present disclosure provide a computer-readable storage medium. The computer-readable storage medium a computer program stored thereon. The computer program is adapted to be loaded by a processor to perform the financial market list display method as described in any of the above embodiments.

The embodiments of the present disclosure provide the financial market list display method and apparatus, the storage medium, and the device. The list drawing instruction triggered based on the list update event is obtained, in which the list update event includes the information update record for the target financial market in the financial market list; the target cell corresponding to the target financial market in the financial market list is determined based on the list drawing instruction, and the target content of the target cell is redrawn based on the information update record of the target financial market by invoking the cell drawing device corresponding to the target cell; and the redrawn target content of the target cell is displayed in the financial market list displayed on the display interface. In the embodiments of the present disclosure, the target content of the target cell can be redrawn by invoking the cell drawing device corresponding to the target cell with the changed financial market in the list, to realize a local change in cell granularity and a high efficiency in responding to data changes, improve drawing efficiency, and thus improve display efficiency and real-time performance of virtual resources.

### BRIEF DESCRIPTION OF THE DRAWINGS

In order to clearly explain technical solutions in the embodiments of the present disclosure, drawings used in description of the embodiments will be briefly described below. The drawings described below merely illustrate some embodiments of the present disclosure. Based on these drawings, other drawings can be obtained by those skilled in the art without inventive effort.

FIG. 1 is a schematic flowchart of a financial market list display method according to an embodiment of the present disclosure.

FIG. 2 is a schematic diagram of an application scenario of a financial market list display method according to an embodiment of the present disclosure.

FIG. 3 is a framework diagram of a financial market list according to an embodiment of the present disclosure.

FIG. 4 is a schematic flowchart of drawing a cell content according to an embodiment of the present disclosure.

FIG. 5 is a structural schematic diagram of a financial market list display apparatus according to an embodiment of the present disclosure.

FIG. 6 is a structural schematic diagram of a terminal device according to an embodiment of the present disclosure.

### DETAILED DESCRIPTION OF THE EMBODIMENTS

The technical solutions in the embodiments of the present disclosure will be described clearly and completely with reference to the drawings in the embodiments of the present disclosure. Obviously, the embodiments described here are only some embodiments of the present disclosure and are not all embodiments of the present disclosure. Based on the embodiments in the present disclosure, other embodiments obtained by those skilled in the art without inventive labor are within scope of the present disclosure.

Embodiments of the present disclosure provide a financial market list display method and apparatus, a storage medium, and a device. The financial market list display method according to the embodiments of the present disclosure can be performed by a terminal device. The terminal device can be a device such as a terminal or a server. The terminal can be a terminal device such as a smart phone, a tablet computer, a laptop, a touch screen, a game console, a personal computer (PC), and a personal digital assistant (PDA). The terminal can also include a client, which can be a financial application client, a browser client carrying a financial transaction program, or an instant messaging client, etc. The server can be an independent physical server, or a server cluster composed of a plurality of physical servers or a distributed system, or a cloud server that provides basic cloud computing services such as cloud services, cloud databases, cloud computing, cloud functions, cloud storage, network services, cloud communications, middleware services, domain name services, security services, content distribution network services, and big data, and artificial intelligence platforms, and the present disclosure is not limited thereto.

A detailed description is made below. It should be noted that an order in which embodiments will be described below should not be construed as a limitation on priority of the embodiments.

Embodiments of the present disclosure provide a financial market list display method, which can be performed by a terminal or a server, or by a terminal and a server together. A financial market list display method performed by a terminal is described as an example in the embodiments of the present disclosure.

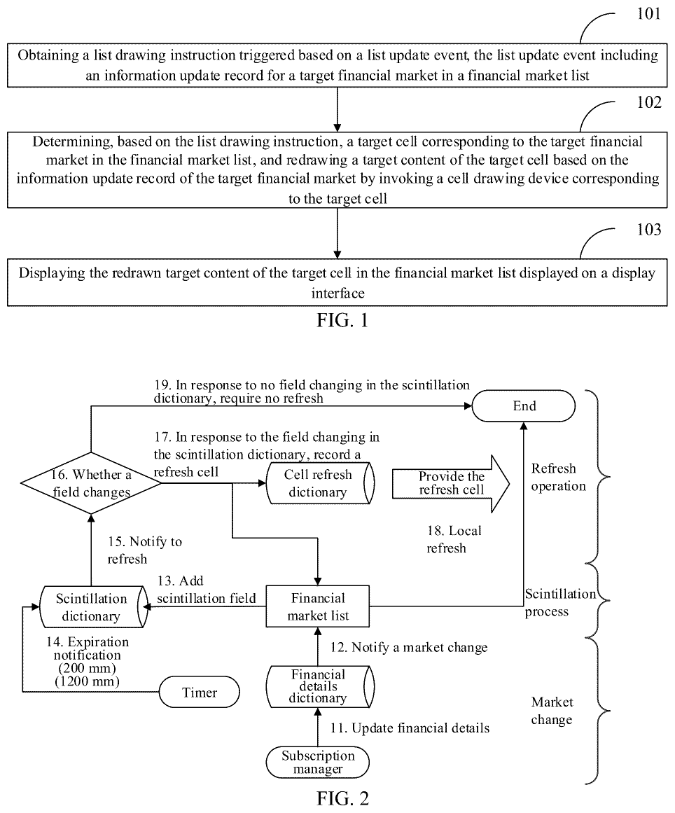

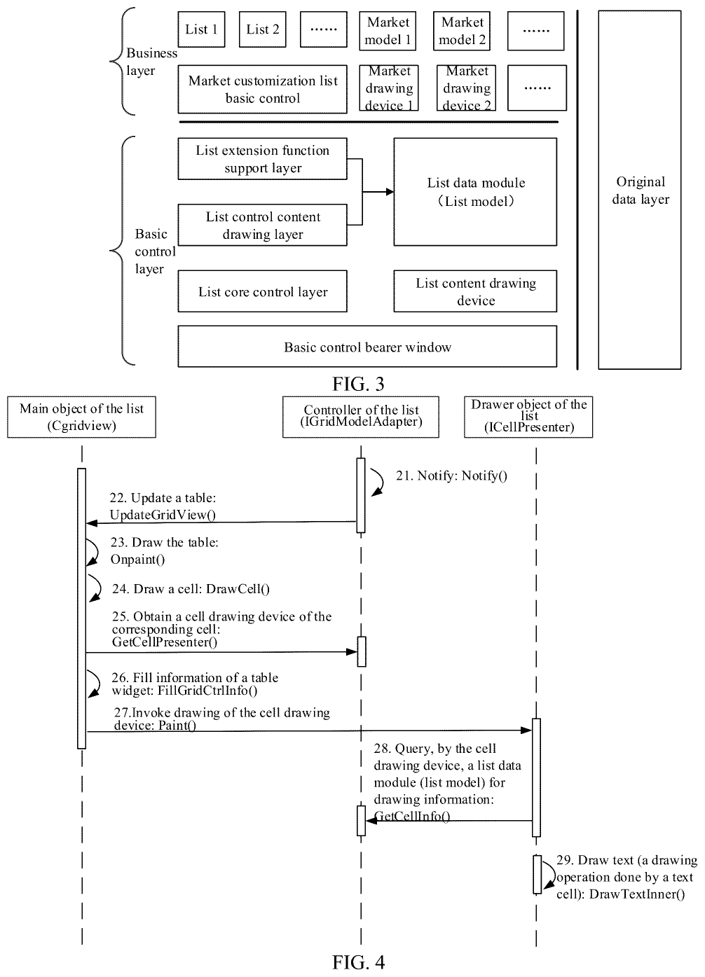

Referring to FIGS. 1 to 4, FIG. 1 is a schematic flowchart of a financial market list display method according to an embodiment of the present disclosure; FIG. 2 is schematic diagram of an application scenario of a financial market list display method according to an embodiment of the present disclosure; FIG. 3 is a framework diagram of a financial market list according to an embodiment of the present disclosure; and FIG. 4 is a schematic flowchart of drawing a cell content according to an embodiment of the present disclosure. It should be noted that the financial market list display method according to the embodiments of the present disclosure can be applied in a financial market list display apparatus according to embodiments of the present disclosure, and the financial market list display apparatus can be configured on a terminal device. The terminal device is configured with a client, and a graphical user interface is provided on the client of the terminal device, and a financial market list can be displayed on the graphical user interface. The method includes actions at steps 101 to 103.

At step 101, a list drawing instruction triggered based on a list update event is obtained, and the list update event includes an information update record for a target financial market in a financial market list.

For example, finance can include any one or more of financial products such as stocks, bonds, funds, foreign exchange, indices, exchange traded funds (ETFs), options, and futures. The financial market list may include a stock market list, a bond market list, a fund market list, a foreign exchange market list, an index market list, an ETF market list, an options market list, a futures market list, etc.

In some embodiments, the method further includes, prior to the obtaining the list drawing instruction triggered based on the list update event:
generating the list update event in response to detecting a change in a financial market;
storing the information update record for the target financial market in the financial market list in the list update event into a scintillation dictionary;
starting a timer, and traversing, in response to the timer having expired, target finance with a changed financial market in the scintillation dictionary; and
obtaining a number of time slices corresponding to the target finance, and triggering the list drawing instruction when the number of time slices corresponding to the target finance becomes zero.

In some embodiments, the method further includes, prior to the obtaining the number of the time slices corresponding to the target finance:
reducing a number of time slices corresponding to the target finance.

For example, in a schematic diagram of an application scenario shown in FIG. 2, at step 11, information on financial details is obtained by a subscription manager, and the information on the financial details is updated into a financial details dictionary; at step 12, when a financial market changes, a market change is notified to a financial market list, and a list update event is generated; at step 13, the financial market list adds a scintillation field containing the list update event into a scintillation dictionary, which is an auxiliary object of the financial market list and can be placed in a data layer of the financial market list; at step 14, a timer is started when the financial market change is identified, a financial item with a changed financial market in the scintillation dictionary is traversed each time the timer expires, in which the financial item with the changed financial market is target finance, a number of time slices of the corresponding financial item is reduced, and an expiration notification such as a 200 mm expiration notification and a 1200 mm expiration notification is automatically issued when the number of the time slices becomes 0; at step 15, a list drawing instruction is triggered to notify the financial market list to perform a User Interface (UI) refresh; at step 16, after the financial market list receives the list drawing instruction for instructing the UI refresh, cells that need to be redrawn are queried by determining whether a field changes in the scintillation dictionary, in response to the field changing in the scintillation dictionary, step 17 is performed, and in response to no field changing in the scintillation dictionary, step 19 is performed; at step 17, in response to the field changing in the scintillation dictionary, a refresh cell is recorded, which is a target cell corresponding to a target financial market with a changed financial market that needs to be redrawn in the financial market list, and the refresh cell (the target cell) is provided based on a cell refresh dictionary; at step 18, a target content of the target cell is redrawn by invoking a cell drawing device corresponding to the target cell, to achieve a local refresh of the financial market list; and at step 19, in response to no field changing in the scintillation dictionary, no refresh is required.

The steps 11 and 12 belong to a market change stage; the steps 13 and 14 belong to a scintillation process stage; and the steps 15 to 19 are a refresh operation stage.

The scintillation process can include highlighting, highlighting retention, and highlighting cancel.

At step 102, a target cell corresponding to the target financial market in the financial market list is determined based on the list drawing instruction, and a target content of the target cell is redrawn based on the information update record of the target financial market by invoking a cell drawing device corresponding to the target cell.

For example, at steps 16 to 18 shown in FIG. 2: at step 16, after the financial market list receives the list drawing instruction for instructing the UI refresh, cells that need to be redrawn are queried by determining whether a field changes in the scintillation dictionary, in response to the field changing in the scintillation dictionary, step 17 is performed, and in response to no field changing in the scintillation dictionary, step 19 is performed; at step 17, in response to the field changing in the scintillation dictionary, a refresh cell is recorded, and the refresh cell is a target cell corresponding to a target financial market with a changed financial market that needs to be redrawn in the financial market list, and the refresh cell (the target cell) is provided based on a cell refresh dictionary; and at step 18, a target content of the target cell is redrawn by invoking a cell drawing device corresponding to the target cell, to achieve a local refresh of the financial market list.

In some embodiments, the cell drawing device includes a list data module and a list content drawing device.

The redrawing the target content of the target cell based on the information update record of the target financial market by invoking the cell drawing device corresponding to the target cell includes:
invoking the cell drawing device corresponding to the target cell;
providing list data of the target financial market based on the list data module of the cell drawing device, generating drawing content indication information based on an information update record in the list data of the target financial market; and
redrawing, by using the list content drawing device of the cell drawing device, the target content of the target cell based on the drawing content indication information.

In a framework diagram of a financial market list shown in FIG. 3, the financial market list can include an original data layer, a basic control layer, and a business layer. The basic control layer can include a basic control receiving window, a list core control layer, a list control content drawing layer, a list extension function support layer, a list data module (list model), and a list content drawing device. The business layer includes a market customization list basic control, each list, each market model, and each market drawing device.

Two key parts of the cell drawing device include the list data module (the list model) in the basic control layer and the list content drawing device which constitute the cell drawing device.

In some embodiments, the method further includes, prior to the providing the list data of the target financial market based on the list data module of the cell drawing device:
determining, based on a data change condition within adjacent predetermined time periods, variation data with a change;
encapsulating the variation data and a business logic used for list processing, and generating a unified interface, to construct the list data module, the list data module being configured to provide the list content drawing device with all information needed for the drawing.

The list data module (the list model) is encapsulated list data. The list model encapsulates the variation data with a change within the adjacent time periods and the business logic, and generates the unified interface, to construct the list data module. The business logic is used to determine a display mode of the list based on the data change situation. The list data module is configured to provide the list content drawing device with all the information needed for the drawing. When the data inside the list model changes, the content drawn by the list content drawing device also changes correspondingly. In this embodiment, list data of the target financial market is provided based on the list data module of the cell drawing device, and drawing content indication information is generated based on an information update record in the list data of the target financial market.

In a process of encapsulating the list data in this embodiment, the variation data with a change is determined by comparing the data in adjacent time periods, and is encapsulated with the business logic. Further, in the encapsulation process, a variation parameter corresponding to a reference data value Dat_i of a current cycle Ti and a reference data value Datᵢ₋₁ in a previous cycle Tᵢ₋₁ can be calculated as:

$$Par\_i = α \cdot {log}_{2} Dat\_i \cdot {e}^{- ( Dat \_ i - D a {t}_{i - 1} )} ,$$

where α represents a predetermined variation factor, and in this embodiment, the previous cycle Tᵢ₋₁ is formed by a plurality of adjacent time periods. After the variation parameter is determined, it is encapsulated into the list data module based on a predetermined variation parameter threshold range and a display logic corresponding to the predetermined variation parameter threshold range. It is used to display the data in a corresponding display mode when a data change during a time period of a certain cycle exceeds a threshold. The above-mentioned list data module can only encapsulate the variation data with a change while considering a problem of data change amplitude as much as possible in the data display process, avoiding data redundancy caused by the encapsulation of all the data, reducing data processing volume, and improving data processing and display efficiency.

In some embodiments, the method further includes, prior to the redrawing, by using the list content drawing device of the cell drawing device, the target content of the target cell based on the drawing content indication information:
encapsulating a display mode of all list cell content to construct the list content drawing device.

The list content drawing device is constructed by encapsulating the display mode of all the list cell contents. The list content drawing device differs from a cell UI object in a conventional list. The list content drawing device is not a sub-UI object of a table. When the list content changes, the list content drawing device does not need to do additional layout calculations, saving a lot of layout time. Meanwhile, the list content drawing device is also an object, and various drawing device objects can be customized in a polymorphic way. In this embodiment, the target content of the target cell is redrawn by using the list content drawing device of the cell drawing device based on the drawing content indication information.

For example, after the financial market list receives the list drawing instruction of the list triggered by the list update event, the list cell content is drawn, and the list does not perform an actual drawing operation, but delegates a corresponding cell drawing device to perform the drawing operation. By default, the cell drawing device is bound to a column in the financial market list. The cell drawing device defines how a cell in a specific column is displayed. Content information that the cell needs to display can be obtained by the list data module.

A schematic flowchart of drawing a cell content as shown in FIG. 4 is specifically described as follows:
CGridview, a main object of the list;
IGridModelAdapter, similar to a controller of the list, which mainly provides the list with data needed for a display and processes the business logic of the list; and
ICellPresenter, a drawing device object of the list, different cells correspond to different cell drawing devices, and all the cell drawing devices provide the list with a display service of a cell content in accordance with a unified interface.

Steps are described as follows:
21. Notify: Notify( );
22. Update a table: UpdateGridView( );
23. Draw the table: Onpaint( );
24. Draw a cell: DrawCell( );
25. Obtain a cell drawing device of the corresponding cell: GetCellPresenter( );
26. Fill information of a table control: FillGridCtrlInfo( );
27. Invoke drawing of the cell drawing device: Paint( );
28. Query, by the cell drawing device, a list data module (list model) for drawing information: GetCellInfo( );
29. Draw text (a drawing operation done by a text cell): DrawTextInner( ).

In the financial market list, when a price of target finance changes, corresponding display data of the target finance also needs to change. In this case, only a target content of a target cell corresponding to the changed target finance needs to be redrawn, without redrawing the entire list. Drawing the target content of the target cell with the cell drawing device greatly improves drawing efficiency.

At step 103, the redrawn target content of the target cell is displayed in the financial market list displayed on a display interface.

In some embodiments, the target content includes cell data and a cell background; and the method further includes, in response to the displaying the redrawn target content of the target cell:
when the target content indicates that a price of target finance increases, displaying, within a predetermined time period, cell data and/or a cell background of the target cell based on a first predetermined display mode, the first predetermined display mode including any one of a scintillation display, a background color change display, or a cell data color change display; and
when the target content indicates that the price of the target finance falls, displaying, within a predetermined time period, cell data and/or a cell background of the target cell based on a second predetermined display mode, the second predetermined display mode including any one of a scintillation display, a background color change display, or a cell data color change display.

For example, when the redrawn target content of the target cell is displayed, cell data or a cell background in the target content of the target cell is highlighted. For example, the highlighting can include a scintillation display, a background color change display, a cell data color change display, etc.

For example, when the first predetermined display mode is the cell data color change display, if the target content indicates that the price of the target finance increases, the cell data of the target cell is displayed in a red color within the predetermined time period.

For example, when the second predetermined display mode is the cell data color change display, if the target content indicates that the price of the target finance falls, the cell data of the target cell is displayed in a green color within the predetermined time period.

For example, the cell drawing device can support both a red-for-increasing and green-for-falling function of a financial price, that is, when the price increases, cell data of the corresponding financial price in the target cell turns red for a period of time; and when the price falls, the cell data turns green for a period of time.

For example, when the first predetermined display mode is the background color change display, if the target content indicates that the price of the target finance increases, the cell background of the target cell is displayed in a red color within the predetermined time period.

For example, when the second predetermined display mode is the background color change display, if the target content indicates that the price of the target finance falls, the cell background of the target cell is displayed in a green color within the predetermined time period.

For example, the cell drawing device can support both a red-for-increasing and green-for-falling function of a financial price, that is, when the price increases, a cell background of the corresponding financial price in the target cell turns red for a period of time; and when the price falls, the cell background turns green for a period of time.

In order to efficiently realize the red-for-increasing and green-for-falling function and support the local change in the cell granularity, the cell drawing device can combine the refresh dictionary with the time slice. For example, a to-be-highlighted cell can be located based on a refresh dictionary, and whether the predetermined time period is reached can be monitored based on the time slice.

For example, when the first predetermined display mode and the first predetermined display mode are each the scintillation display, if the target content indicates that the price of the target finance increases, the cell data and/or the cell background of the target cell are displayed based on a scintillation display mode between a black color and a red color within the predetermined time period; if the target content indicates that the price of the target finance falls, the cell data and/or the cell background of the target cell are displayed based on a scintillation display mode between a black color and a green color within the predetermined time period.

In the embodiments of the present disclosure, the cell drawing of the list is handled by the corresponding cell drawing device. The cell drawing device serves as a set of abstract interfaces for content drawing, which can provide sufficient customization and extension capabilities. Moreover, the cell drawing device is independent from a family tree of a table UI control, and therefore the cell drawing device does not increase computational consumption of a table UI layout, which greatly improves drawing efficiency. In addition, the local refresh operation of the cell granularity can be controlled based on the cell highlighting logic of the time slice and the refresh dictionary. In this way, the list can provide an efficient and smooth red-for-increasing and green-for-falling change effect.

All of the above technical solutions can be combined in any way to form an embodiment of the present disclosure, and details thereof will not be described herein.

In the embodiments of the present disclosure, the list drawing instruction triggered based on the list update event is obtained, in which the list update event includes the information update record for the target financial market in the financial market list; the target cell corresponding to the target financial market in the financial market list is determined based on the list drawing instruction, and the target content of the target cell is redrawn based on the information update record of the target financial market by invoking the cell drawing device corresponding to the target cell; and the redrawn target content of the target cell is displayed in the financial market list displayed on the display interface. In the embodiments of the present disclosure, the target content of the target cell can be redrawn by invoking the cell drawing device corresponding to the target cell with the changed financial market in the list, to realize the local change in the cell granularity and a high efficiency in responding to the data change, improve the drawing efficiency, and thus improve the display efficiency and the real-time performance of virtual resources.

In order to facilitate better implementation of the financial market list display method according to the embodiments of the present disclosure, embodiments of the present disclosure also provide a financial market list display apparatus. Referring to FIG. 5, FIG. 5 is a structural schematic diagram of a financial market list display apparatus according to an embodiment of the present disclosure. A financial market list display apparatus 200 can include:
an obtaining unit 201 configured to obtain a list drawing instruction triggered based on a list update event, in which the list update event includes an information update record for a target financial market in a financial market list;
a processing unit 202 configured to determine, based on the list drawing instruction, a target cell corresponding to the target financial market in the financial market list, and redraw a target content of the target cell based on the information update record of the target financial market by invoking a cell drawing device corresponding to the target cell; and
a display unit 203 configured to display the redrawn target content of the target cell in the financial market list displayed on a display interface.

In some embodiments, the cell drawing device includes a list data module and a list content drawing device; and the processing unit 202 is specifically configured to, when the target content of the target cell is redrawn based on the information update record of the target financial market by invoking the cell drawing device corresponding to the target cell:
invoke the cell drawing device corresponding to the target cell;
provide list data of the target financial market based on the list data module of the cell drawing device, and generate drawing content indication information based on an information update record in the list data of the target financial market; and
redraw, by using the list content drawing device of the cell drawing device, the target content of the target cell based on the drawing content indication information.

In some embodiments, the processing unit 202 is further configured to, prior to the providing the list data of the target financial market based on the list data module of the cell drawing device:
determine, based on a data change condition within adjacent predetermined time periods, variation data with a change;
encapsulate the variation data and a business logic used for list processing, and generate a unified interface, to construct the list data module. The list data module is configured to provide the list content drawing device with all information needed for the drawing.

In some embodiments, the processing unit 202 is further configured to, prior to the redrawing, by using the list content drawing device of the cell drawing device, the target content of the target cell based on the drawing content indication information:
encapsulate a display mode of all list cell content to construct the list content drawing device.

In some embodiments, the obtaining unit 201 is further configured to, prior to the obtaining the list drawing instruction triggered based on the list update event:
generate the list update event in response to detecting a change in a financial market;
store the information update record for the target financial market in the financial market list in the list update event into a scintillation dictionary;
start a timer, and traversing, in response to the timer having expired, target finance with a changed financial market in the scintillation dictionary; and
obtain a number of time slices corresponding to the target finance, and trigger the list drawing instruction when the number of time slices corresponding to the target finance becomes zero.

In some embodiments, the obtaining unit 201 is further configured to, prior to the obtaining the number of the time slices corresponding to the target finance: reduce a number of time slices corresponding to the target finance.

In some embodiments, the target content includes cell data and a cell background; and the display unit 203 is further configured to, in response to the displaying the redrawn target content of the target cell:
when the target content indicates that a price of target finance increases, display, within a predetermined time period, cell data and/or a cell background of the target cell based on a first predetermined display mode, the first predetermined display mode including any one of a scintillation display, a background color change display, or a cell data color change display; and
when the target content indicates that the price of the target finance falls, display, within a predetermined time period, cell data and/or a cell background of the target cell based on a second predetermined display mode, the second predetermined display mode including any one of a scintillation display, a background color change display, or a cell data color change display.

All of the above technical solutions can be combined in any way to form an embodiment of the present disclosure, and details thereof will not be described herein.

It should be understood that the apparatus embodiments can correspond to the method embodiments, and similar descriptions thereof can refer to those of the method embodiments. To avoid repetition, no further description is given herein. Specifically, the apparatus shown in FIG. 5 can perform the above financial market list display method embodiments, and the aforementioned and other operations and/or functions of each unit in the apparatus implement the corresponding processes of the above method embodiments, respectively, and details thereof will not be described herein for the sake of brevity.

Embodiments of the present disclosure also provide a computer device. The computer device includes a memory and a processor. The memory has a computer program stored thereon. The processor, when executing the computer program, implements the steps in the above method embodiments.

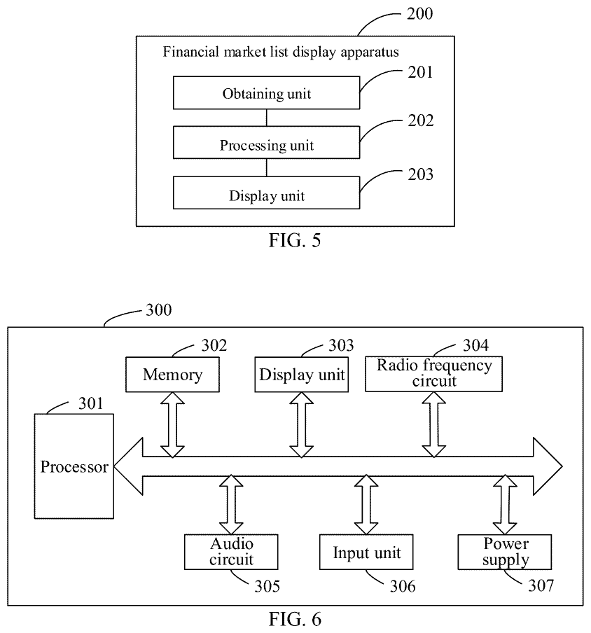

Correspondingly, embodiments of the present disclosure also provide a terminal device, which can be a terminal or a server. As shown in FIG. 6, FIG. 6 is a structural schematic diagram of a terminal device according to an embodiment of the present disclosure. A terminal device 300 includes a processor 301 with one or more processing cores, a memory 302 with one or more computer-readable storage media, and a computer program stored in the memory 302 and executable by the processor. The processor 301 is electrically connected to the memory 302. It can be understood by those skilled in the art that a structure of the terminal device shown in the figure does not constitute a limitation on the terminal device, and the terminal device can include more or fewer components than those shown, or combine certain components, or have different arrangement of components.

The processor 301 is a control center of the terminal device 300, which uses various interfaces and lines to connect various parts of the entire terminal device 300. By running or loading software programs and/or modules stored in the memory 302, and by invoking data stored in the memory 302, various functions and data processing of the terminal device 300 are executed, thus monitoring the terminal device 300 as a whole.

In the embodiments of the present disclosure, the processor 301 of the terminal device 300 loads instructions corresponding to processes of one or more applications into the memory 302 and executes the application programs stored in the memory 302 to achieve various functions in accordance with the following steps:
obtaining a list drawing instruction triggered based on a list update event, the list update event including an information update record for a target financial market in a financial market list; determining, based on the list drawing instruction, a target cell corresponding to the target financial market in the financial market list, and redrawing a target content of the target cell based on the information update record of the target financial market by invoking a cell drawing device corresponding to the target cell; and displaying the redrawn target content of the target cell in the financial market list displayed on a display interface.

Reference of the specific implementation of the above respective operations can be made to the previous embodiments, and details thereof will not be described herein.

In some embodiments, as shown in FIG. 6, the terminal device 300 further includes a display unit 303, a radio frequency circuit 304, an audio circuit 305, an input unit 306, and a power supply 307. The processor 301 is electrically connected to each of the display unit 303, the radio frequency circuit 304, the audio circuit 305, the input unit 306, and the power supply 307. It can be understood by those skilled in the art that a structure of the terminal device shown in FIG. 6 does not constitute a limitation on the terminal device, and the terminal device can include more or fewer components than those shown, or combine certain components, or have different arrangement of components.

The display unit 303 can be configured to display information input by a user or information provided to the user, and various graphical user interfaces of the terminal device. The graphical user interface can be formed by graphics, text, icons, videos, and any combination thereof. The display unit 303 can include a display panel and a touch panel.

The radio frequency circuit 304 can be configured to transmit and receive radio frequency signals to establish wireless communication with network devices or other terminal devices through wireless communication, and to transmit and receive signals among the network devices or other terminal devices.

The audio circuit 305 can be configured to provide an audio interface between the user and the terminal device through a speaker and a microphone. The audio circuit 305 can transmit an electrical signal converted from received audio data to the speaker, which converts the electrical signal into a sound signal for output. On the other hand, the microphone converts a collected sound signal into an electrical signal, which is received by the audio circuit 305 and converted into audio data. Then, the audio data is output to the processor 301 for processing to be transmitted to another terminal device through the radio frequency circuit 304, or the audio data is output to the memory 302 for further processing. The audio circuit 305 can further include an earplug socket to provide communication between an external earphone and the terminal device.

The input unit 306 can be configured to receive input digits, character information, or user character information (such as fingerprint, iris, and facial information), and generate signal inputs related to user settings and function control, such as a keyboard, a mouse, a joystick, an optical inputs, or a trackball.

The power supply 307 is configured to power various components of the terminal device 300. In some embodiments, the power supply 307 can be logically connected to the processor 301 through a power management system, and therefore the power management system can realize functions such as charging and discharging management and power consumption management. The power supply 307 can also include any components such as one or more direct-current or alternating-current power supplies, recharging systems, power fault detection circuits, power converters or inverters, and power status indicators.

Although not shown in FIG. 6, the terminal device 300 can further include cameras, sensors, wireless fidelity modules, Bluetooth modules, etc., and details thereof will not be described herein.

Reference of the specific implementation of the above respective operations can be made to the previous embodiments, and details thereof will not be described herein.

It can be understood by those skilled in the art that all or a part of the steps in the method in the above-mentioned embodiments may be completed by instructions, or by controlling relevant hardware through the instructions. The instructions may be stored in a computer-readable storage medium and loaded and executed by the processor.

To this end, embodiments of the present disclosure provide a computer-readable storage medium. The storage medium has a plurality of computer programs stored thereon. The plurality of computer programs can be loaded by a processor to perform the steps in any of the financial market list display methods according to the embodiments of the present disclosure.

Reference of the specific implementation of the above respective operations can be made to the previous embodiments, and details thereof will not be described herein.

The storage medium can include Read Only Memories (ROMs), Random Access Memories (RAMs), magnetic disks, or CD, etc.

Since the computer program stored in the storage medium can perform the steps in any of the financial market list display methods according to the embodiments of the present disclosure, it can achieve the beneficial effects that can be achieved by any of the financial market list display methods according to the embodiments of the present disclosure, and thus the description thereof in detail can refer to the previous embodiments, which will be omitted herein.

The present disclosure also provides a computer program product, which includes computer instructions, and the computer instructions are stored in a computer-readable storage medium. A processor of the computer device reads the computer instructions from the computer-readable storage medium and executes the computer instructions, to cause a computer device to perform the corresponding process in the financial market list display method according to the embodiments of the present disclosure, and details thereof will not be described herein for the sake of brevity.

The present disclosure also provides a computer program, which includes computer instructions, and the computer instructions are stored in a computer-readable storage medium. A processor of the computer device reads the computer instructions from the computer-readable storage medium and executes the computer instructions, to cause a computer device to perform the corresponding process in the financial market list display method according to the embodiments of the present disclosure, and details thereof will not be described herein for the sake of brevity.

Detailed description of the financial market list display method and apparatus, the storage medium, and the device is made above. Specific examples are used herein to illustrate the principles and implementations of the present disclosure. The description of the above embodiments is only used to facilitate understanding of the method and a core idea thereof of the present disclosure. In addition, for those skilled in the art, according to the concept of the present disclosure, changes can be made to the specific implementations and the scope of application. In summary, the content of the specification should not be construed as a limitation on the present disclosure.

What is claimed is:

1. A financial market list display method, comprising:
obtaining a list drawing instruction triggered based on a list update event, the list update event comprising an information update record for a target financial market in a financial market list;
determining, based on the list drawing instruction, a target cell corresponding to the target financial market in the financial market list, and redrawing a target content of the target cell based on the information update record of the target financial market by invoking a cell drawing device corresponding to the target cell; and
displaying the redrawn target content of the target cell in the financial market list displayed on a display interface.

2. The financial market list display method according to claim 1, wherein:
the cell drawing device comprises a list data module and a list content drawing device;
said redrawing the target content of the target cell based on the information update record of the target financial market by invoking the cell drawing device corresponding to the target cell comprises:
invoking the cell drawing device corresponding to the target cell;
providing list data of the target financial market based on the list data module of the cell drawing device, generating drawing content indication information based on an information update record in the list data of the target financial market; and
redrawing, by using the list content drawing device of the cell drawing device, the target content of the target cell based on the drawing content indication information.

3. The financial market list display method according to claim 2, further comprising, prior to said providing the list data of the target financial market based on the list data module of the cell drawing device:
determining, based on a data change condition within adjacent predetermined periods, variation data with a change;
encapsulating the variation data and a business logic used for list processing, and generating a unified interface, to construct the list data module, the list data module being configured to provide the list content drawing device with all information needed for drawing.

4. The financial market list display method according to claim 2, further comprising, prior to said redrawing, by using the list content drawing device of the cell drawing device, the target content of the target cell based on the drawing content indication information:
encapsulating a display mode of all list cell content to construct the list content drawing device.

5. The financial market list display method according to claim 1, further comprising, prior to said obtaining the list drawing instruction triggered based on the list update event:
generating the list update event in response to detecting a change in a financial market;
storing into a scintillation dictionary the information update record for the target financial market in the financial market list in the list update event;
starting a timer, and traversing in the scintillation dictionary, in response to the timer having expired, target finance with a changed financial market; and
obtaining a number of time slices corresponding to the target finance, and triggering the list drawing instruction when the number of time slices corresponding to the target finance becomes zero.

6. The financial market list display method according to claim 5, further comprising, prior to said obtaining the number of the time slices corresponding to the target finance:
reducing the number of time slices corresponding to the target finance.

7. The financial market list display method according to claim 1, wherein the target content comprises cell data and a cell background,
wherein the method further comprises, in response to said displaying the redrawn target content of the target cell:
when the target content indicates that a price of target finance increases, displaying, within a predetermined time period, cell data and/or a cell background of the target cell based on a first predetermined display mode, the first predetermined display mode comprising any one of a scintillation display, a background color change display, or a cell data color change display; and
when the target content indicates that the price of the target finance falls, displaying, within a predetermined time period, cell data and/or a cell background of the target cell based on a second predetermined display mode, the second predetermined display mode comprising any one of a scintillation display, a background color change display, or a cell data color change display.

8. A computer-readable storage medium, having a computer program stored thereon,
wherein the computer program is adapted to be loaded by a processor to perform a financial market list display method, the method comprising:
obtaining a list drawing instruction triggered based on a list update event, the list update event comprising an information update record for a target financial market in a financial market list;
determining, based on the list drawing instruction, a target cell corresponding to the target financial market in the financial market list, and redrawing a target content of the target cell based on the information update record of the target financial market by invoking a cell drawing device corresponding to the target cell; and
displaying the redrawn target content of the target cell in the financial market list displayed on a display interface.

9. The storage medium according to claim 8, wherein:
the cell drawing device comprises a list data module and a list content drawing device;
said redrawing the target content of the target cell based on the information update record of the target financial market by invoking the cell drawing device corresponding to the target cell comprises:
invoking the cell drawing device corresponding to the target cell;
providing list data of the target financial market based on the list data module of the cell drawing device, generating drawing content indication information based on an information update record in the list data of the target financial market; and
redrawing, by using the list content drawing device of the cell drawing device, the target content of the target cell based on the drawing content indication information.

10. The storage medium according to claim 9, wherein the method further comprises, prior to said providing the list data of the target financial market based on the list data module of the cell drawing device:
determining, based on a data change condition within adjacent predetermined periods, variation data with a change;
encapsulating the variation data and a business logic used for list processing, and generating a unified interface, to construct the list data module, the list data module being configured to provide the list content drawing device with all information needed for drawing.

11. The storage medium according to claim 9, wherein the method further comprises, prior to said redrawing, by using the list content drawing device of the cell drawing device, the target content of the target cell based on the drawing content indication information:
encapsulating a display mode of all list cell content to construct the list content drawing device.

12. The storage medium according to claim 8, wherein the method further comprises, prior to said obtaining the list drawing instruction triggered based on the list update event:
generating the list update event in response to detecting a change in a financial market;
storing into a scintillation dictionary the information update record for the target financial market in the financial market list in the list update event;
starting a timer, and traversing in the scintillation dictionary, in response to the timer having expired, target finance with a changed financial market; and
obtaining a number of time slices corresponding to the target finance, and triggering the list drawing instruction when the number of time slices corresponding to the target finance becomes zero.

13. The storage medium according to claim 12, wherein the method further comprises, prior to said obtaining the number of the time slices corresponding to the target finance:
reducing the number of time slices corresponding to the target finance.

14. The storage medium according to claim 8, wherein the target content comprises cell data and a cell background,
wherein the method further comprises, in response to said displaying the redrawn target content of the target cell:
when the target content indicates that a price of target finance increases, displaying, within a predetermined time period, cell data and/or a cell background of the target cell based on a first predetermined display mode, the first predetermined display mode comprising any one of a scintillation display, a background color change display, or a cell data color change display; and
when the target content indicates that the price of the target finance falls, displaying, within a predetermined time period, cell data and/or a cell background of the target cell based on a second predetermined display mode, the second predetermined display mode comprising any one of a scintillation display, a background color change display, or a cell data color change display.

15. A computer device, comprising:
a processor; and
a memory having a computer program stored thereon,
wherein the processor is configured to invoke the computer program stored in the memory to perform a financial market list display method, the method further comprises:
obtaining a list drawing instruction triggered based on a list update event, the list update event comprising an information update record for a target financial market in a financial market list;
determining, based on the list drawing instruction, a target cell corresponding to the target financial market in the financial market list, and redrawing a target content of the target cell based on the information update record of the target financial market by invoking a cell drawing device corresponding to the target cell; and
displaying the redrawn target content of the target cell in the financial market list displayed on a display interface.

16. The computer device according to claim 15, wherein:
the cell drawing device comprises a list data module and a list content drawing device;
said redrawing the target content of the target cell based on the information update record of the target financial market by invoking the cell drawing device corresponding to the target cell comprises:
invoking the cell drawing device corresponding to the target cell;
providing list data of the target financial market based on the list data module of the cell drawing device, generating drawing content indication information based on an information update record in the list data of the target financial market; and
redrawing, by using the list content drawing device of the cell drawing device, the target content of the target cell based on the drawing content indication information.

17. The computer device according to claim 16, wherein the method further comprises, prior to said providing the list data of the target financial market based on the list data module of the cell drawing device:
determining, based on a data change condition within adjacent predetermined periods, variation data with a change;
encapsulating the variation data and a business logic used for list processing, and generating a unified interface, to construct the list data module, the list data module being configured to provide the list content drawing device with all information needed for drawing.

18. The computer device according to claim 16, wherein the method further comprises, prior to said redrawing, by using the list content drawing device of the cell drawing device, the target content of the target cell based on the drawing content indication information:
encapsulating a display mode of all list cell content to construct the list content drawing device.

19. The computer device according to claim 15, wherein the method further comprises, prior to said obtaining the list drawing instruction triggered based on the list update event:
generating the list update event in response to detecting a change in a financial market;
storing into a scintillation dictionary the information update record for the target financial market in the financial market list in the list update event;
starting a timer, and traversing in the scintillation dictionary, in response to the timer having expired, target finance with a changed financial market; and
obtaining a number of time slices corresponding to the target finance, and triggering the list drawing instruction when the number of time slices corresponding to the target finance becomes zero.

20. The computer device according to claim 19, wherein the method further comprises, prior to said obtaining the number of the time slices corresponding to the target finance:
reducing the number of time slices corresponding to the target finance.
